(19) United States
(12) Patent Application Publication
(10) Pub. No.: US 2013/0283990 A1
(43) Pub. Date: Oct. 31, 2013

(54) SLIDABLE BLADE TO BE MOUNTED ON A DRUM OF TOBACCO CUTTER

(71) Applicant: Marek Sieredzinski, Radom (PL)

(72) Inventor: Marek Sieredzinski, Radom (PL)

(73) Assignee: INTERNATIONAL TOBACCO MACHINERY POLAND SP. Z O.O., Radom (PL)

(21) Appl. No.: 13/883,438

(22) PCT Filed: Nov. 3, 2011
(86) PCT No.: PCT/PL11/50045

§ 371 Date: Jul. 15, 2013

(30) Foreign Application Priority Data
Nov. 3, 2010 (PL) 392834

(51) Int. Cl. B26D 1/36

(52) U.S. Cl. CPC B26D 1/36
USPC 83/663

(57) ABSTRACT

A slidable blade mounted on a tobacco cutter drum, in the form of a flat plate bevelled on the rim forming the cutting edge, wherein said flat plate (1, 1′) comprises on at least one of the surfaces a plurality of longitudinal grooves (2, 2′) of the depth that is smaller than or equal to the thickness of the said plate, the grooves being oriented substantially perpendicularly to the cutting edge (3, 3′) of the said plate and being arranged substantially in parallel to one another at distances, in at least two series (a, a′, b, b′, c, c′ . . . ) parallel to the cutting edge, said grooves (2, 2′) being situated in consecutive rows in such a way that the longitudinal axis of each groove lies on a line situated between the grooves of the adjacent rows.

The invention relates to a slidable blade mounted on a drum of tobacco cutter.

The tobacco cutters equipped with blade drums with at least two blades are commonly used in the tobacco industry. Most commonly used are the blades having a linear cutting edge. The blades having many collinear cutting edges shaped in such a way as to cut off the tobacco fibres of a predetermined length are also known.

The document WO85/004616 refers to cutting the tobacco fibres of a predetermined length and presents a design of a flat blade bevelled on one side comprising grooves made on the side opposite to the bevelled surface. Small protuberances located between each two adjacent grooves, cut off the fibres to a certain length, i.e. the groove width determines the maximum length of the fibres being cut off and the protuberances have a triangular or square cross section. The length of the grooves formed in the blade determines the life of the blade, which is being sharpened in course of the operation until the blade bevelling “is transferred” to the end level of the grooves.

The document WO95/007031 presents a cutter drum equipped with knives of various thickness and various angular positions. The drum is equipped with at least one knife comprising protuberances situated as in the previous document, on the side opposite to the blade bevelling, the protuberances having a triangular cross section and both ends of the blade being formed as gripping parts which are flat on both sides. Since the described blade may be gripped only at its ends, it needs to be correspondingly thick, which will provide it with a sufficient resistance.

The document WO2004/080215 discloses a flat blade with a plurality of notches provided to cut the fibres at length, the blade being supported by a flat pressing element close to the cutting edge, which enables using a thinner blades, since a part of load is taken over by the pressing element. The pass-through notches formed in the blade are relatively short and therefore such blades need to be replaced more often. The pressing element comprises notches adjusted to the notches in the blade.

The document WO2010/029348 discloses a flat blade the shape of which that is required for cutting is conferred during the operation of the cutter. The plurality of edges used to cut off the fibres widthwise are sharpened by means of a grinding wheel and the notches necessary for cutting off the fibres lengthwise are also formed.

The object of the present invention is to design a blade provided to cut tobacco fibres of a predetermined length, by conferring it high resistance and a shape which enables it to be gripped in the same way as an ordinary blade without any grooves.

According to the invention, a slidable blade is provided that is mounted on a tobacco cutter drum, in the form of a flat plate bevelled on the rim forming the cutting edge, characterised in that said flat plate, on at least one of the surfaces, comprises a plurality of longitudinal grooves, each of the grooves having the depth smaller than or equal to the thickness of the plate, the grooves being oriented substantially perpendicularly to the cutting edge of the said plate and arranged substantially in parallel to one another at distances, in at least two series parallel to the cutting edge, the said grooves being situated in consecutive rows in such a way that the longitudinal axis of each groove lies on a line located between the grooves of the adjacent rows.

Preferably, each of the longitudinal grooves has a V-shaped cross section.

Alternatively, each of the longitudinal grooves may have a rectangular cross section.

Preferably, the contour of each of the grooves on the plate surface is of a rectangular shape.

Preferably, each of the grooves has a depth that is equal to the thickness of the plate.

The blade according to the invention is, in terms of technology, a simple element of the tobacco cutter. It combines high resistance and the functionality of the blades designed to cut off fibres of a predetermined length because it can be pressed to the elements of a cutter drum by its entire surface. The arrangement of the series of grooves ensures higher resistance of the blade as compared to the one having a single row of long holes.

The object of the invention is presented by way of non-limiting example in the drawing, in which:

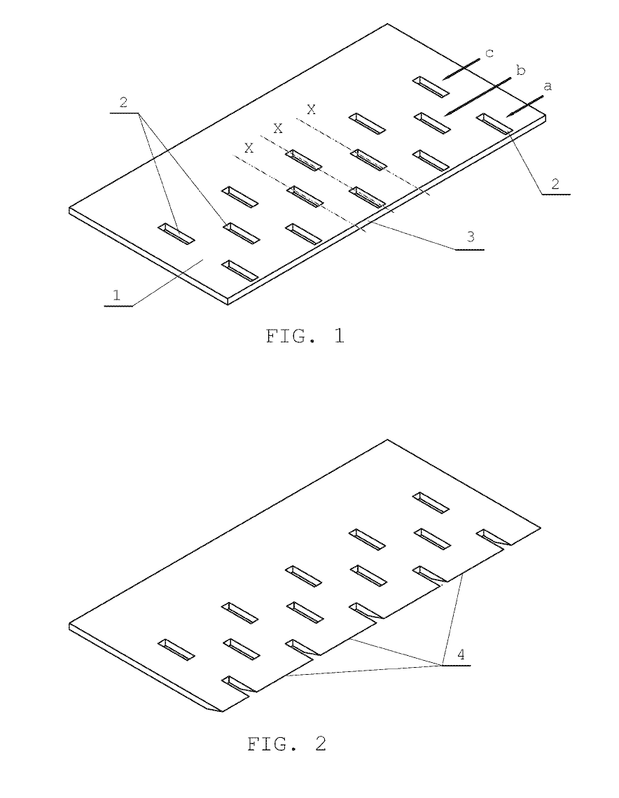

FIG. 1 presents an embodiment of the blade prepared to be arranged on the cutter drum;

FIG. 2 shows the blade from FIG. 1 after the sharpening of the cutting edge;

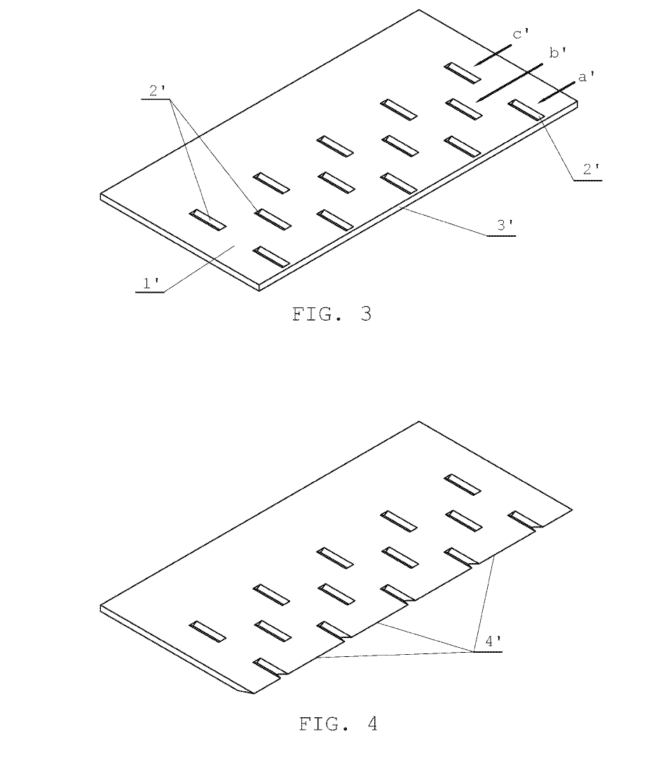

FIG. 3 presents a second embodiment of the blade prepared to be arranged on the cutter drum;

FIG. 4 shows the blade from FIG. 3 after the sharpening of the cutting edge.

The blade shown in FIG. 1 is equipped with three series a, b, c of the grooves 2, having the depth equal to the thickness of the plate 1, which therefore form pass-through holes 2 of a rectangular cross section, the rows a, b, c of the holes 2 being situated in parallel to the edge 3 and the edge 3 of the blade has not been sharpened yet. The grooves, that is the holes 2 in this example, are arranged along the axes X, arranged perpendicularly to the edge 3. FIG. 1 shows only a few axes X. The axes X of the holes 2 in each subsequent row are not aligned with the axes of the holes in a preceding row. In FIG. 1, the holes 2 of the row b lie on the axes X running between the holes 2 of the rows a and c. In the shown embodiment, the axes X of the holes 2 in the row c are aligned with the axes X of the holes 2 in the row a, but an embodiment of the blade, wherein the axes X of the holes 2 are not aligned with the axes X of the holes 2 of any other row, is also possible. The unsharpened blade is sharpened after having been mounted on the cutter drum. As a result, a sharp edge 4 is formed, the length of respective fragments of this edge determining the maximum length of the fibres being cut off. During the cutting operation the blade is being continuously sharpened, which causes the holes 2 to become increasingly shorter. After the blade as been ground such that the cutting edge reaches the end of the holes and during further grinding of the blade, the length of the fibres being cut off will be determined by the spacing of the holes 2 in the second row, and then in the following row.

The blade shown in FIGS. 3 and 4 is equipped with three rows a′, b′ c′ of the grooves 2′ of a triangular cross section, the rows of the grooves 2′ being arranged in parallel to the edge 3′. The edge 3′ of the blade plate 1′ has not been sharpened. Analogously to the blade shown in FIGS. 1-2, the unsharpened blade 1′ is sharpened after having been mounted on the cutter drum, and as a result the sharp edge 4′ is formed, the length of respective fragments of that edge determining the maximum length of the fibres being cut off.

1. A slidable blade mounted on a tobacco cutter drum, in the form of a flat plate bevelled on the rim forming the cutting edge, characterised in that said flat plate (1, 1′) comprises on at least one of the surfaces a plurality of longitudinal grooves (2, 2′), each of the grooves having the depth smaller than or equal to the thickness of the said plate, the grooves being oriented substantially perpendicularly to the cutting edge (3′ 3′) of the said plate and being arranged substantially in parallel to one another at distances in at least two series (a, a′, b, b′, c, c′ . . . ) parallel to the cutting edge, said grooves (2, 2′) being situated in consecutive rows in such a way that the longitudinal axis (X) of each groove lies on a line situated between the grooves of the adjacent rows.

2. The slidable blade according to claim 1, characterised in that each of the longitudinal grooves (2, 2′) has a V-shaped cross section.

3. The slidable blade according to claim 1 characterised in that each of the longitudinal (2, 2′) has a rectangular cross section.

4. The slidable blade according to claim 1, characterised in that the contour of each of the grooves (2, 2′) on the plate surface is of a rectangular shape.

5. The slidable blade according to claim 1, characterised in that each of the longitudinal grooves (2, 2′) has a depth that is equal to the thickness of the plate.
